(19) United States
(12) Patent Application Publication
(10) Pub. No.: US 2011/0176862 A1
(43) Pub. Date: Jul. 21, 2011

(54) LOCKING DEVICE AND LOCKABLE RAIL ASSEMBLY

(76) Inventor: Jo-Chiao WANG, Taipei County (TW)

(21) Appl. No.: 12/817,611

(22) Filed: Jun. 17, 2010

(30) Foreign Application Priority Data
Jan. 15, 2010 (TW) 99200866

(51) Int. Cl. F16B 7/10

(52) U.S. Cl. 403/243

(57) ABSTRACT

A locking device, for locking a sliding member to a guiding member, includes a fixed sleeve with two ends opened, a movable sleeve, and a latching pin. The fixed sleeve is disposed to the guiding member with a positioning block disposed on an outer peripheral surface thereof. The movable sleeve has an open end and a closed end. The fixed sleeve passes through the open end to cover the movable sleeve thereon. A guiding slot is opened on the movable sleeve, and includes a catching section for catching the positioning block and a release section extending toward the open end. The release section is used for guiding the positioning block into or out of the catching section. The latching pin is disposed in the movable sleeve and extends out of the open end for engaging into the sliding member to lock the sliding member to the guiding member.

### CROSS-REFERENCES TO RELATED APPLICATIONS

This non-provisional application claims priority under 35 U.S.C. §119(a) on Patent Application No. 99200866 filed in Taiwan, R.O.C. on Jan. 15, 2010, the entire contents of which are hereby incorporated by reference.

### BACKGROUND OF THE INVENTION

1. Technical Field

The present invention relates to a locking device, and more particularly to a locking device having a good fixing effect and being easily operated, and a lockable rail assembly applying the locking device.

2. Related Art

Referring to FIGS. 1A and 1B, a rail assembly generally includes a guiding member 1 and a sliding member 2. The sliding member 2 is movably combined with the guiding member 1 to slide on the guiding member 1 in a sliding direction M. The sliding member 2 and the guiding member 1 have guiding structures (not shown), matching each other in cross sections perpendicular to the sliding direction. The guiding structures are used for guiding the sliding member 2 to slide in the sliding direction M. Moreover, some types of the guiding structures can prevent the sliding member 2 from directly escaping from the guiding member 1 along a direction perpendicular to the sliding direction M.

In the rail assembly, the guiding member 1 is generally disposed on a fixed base, and an object to be moved is fixed on the sliding member 2. After being moved to a predetermined position, the position of the object sometimes needs to be fixed. The approach for fixing the position of the object is to lock the sliding member 2 directly on the guiding member 1.

FIG. 1A shows a common locking structure in the prior art. The locking structure is a latching pin 3. In order to utilize the latching pin 3, a through hole 1a is disposed on the guiding member 1, and a plurality of positioning holes 2a (only one is shown), arranged in the sliding direction M is disposed on the sliding member 2. When the sliding member 2 drives the object to reach a predetermined position and one of the positioning holes 2a is aligned with the through hole 1a, the latching pin 3 passes through the through hole 1a to be inserted into the positioning hole 2a, thereby locking the sliding member 2 on the guiding member 1.

The locking structure shown in FIG. 1A can achieve the locking effect by using a simple structure, but the latching pin 3 produces no effective fixing force in its axial direction, and thus drops off easily. Although the latching pin 3 can be fixed bin a tighten-fit manner, it is difficult to insert in or pull out the latching pin 3 in the tighten-fit manner.

FIG. 1B shows another locking structure in the prior art. The locking structure is a screwing member 4 having screw threads. In order to match the screwing member 4, a through hole 1b is disposed on the guiding member 1, and a plurality of screw holes 2b (only one is shown), arranged in the sliding direction M is disposed on the sliding member 2. When the through hole 1b is aligned with one of the screw holes 2b, the screwing member 4 passes through the through hole 1b and is screwed into the screw hole 2b, thereby locking the sliding member 2 on the guiding member 1.

The locking structure shown in FIG. 1B has a good locking effect, and does not drop off easily. However, the disadvantage thereof lies in the difficult assembly and disassembly process, which requires considerable time to screw the screwing member 4 in and out and requires an additional tool such as a wrench, a driver, or a sleeve to start the operation of the screwing member 4.

### SUMMARY

In view of the problem that a locking structure for a rail assembly in the prior art may drop off easily or be difficult to operate, the present invention is directed to a locking device having the advantages of being easily operated and achieving a desirable locking effect.

The present invention provides a locking device for locking a rail assembly, which includes a fixed sleeve with two ends opened, a movable sleeve, and a latching pin.

The fixed sleeve is fixed on the rail assembly, and least one positioning block is disposed on an outer peripheral surface of the fixed sleeve.

The movable sleeve has an open end and a closed end. The fixed sleeve passes through the open end to cover the movable sleeve on the fixed sleeve along an axial direction, so as to move or to rotate the movable sleeve relative to the fixed sleeve about the axial direction. The movable sleeve further has a guiding slot opened on an outer peripheral surface thereof. The guiding slot at least includes a catching section for catching the positioning block and at least one release section extending toward the open end for guiding the positioning block into and out of the catching section.

The latching pin is coaxially disposed in the movable sleeve, extends out of the open end, and runs through the fixed sleeve.

The catching section is used for catching the positioning block to fix the movable sleeve at a locking position, so that the latching pin engages into the rail assembly; or the positioning block can escape from the catching slot through the release section to move the movable sleeve to a release position, so that the latching pin is disengaged from the rail assembly.

In one or a plurality of embodiments, the present invention further provides a lockable rail assembly, which includes a guiding member, a sliding member, a fixed sleeve, and a movable sleeve.

The guiding member has a through hole. The sliding member has at least one side surface being covered by the guiding member and is movable combined with guiding member. The sliding member has a plurality of positioning holes arranged in a sliding direction, and one of the positioning holes is selectively aligned with the through hole as the sliding member moves.

The fixed sleeve has two open ends and is fixed on the guiding member, and one end of the fixed sleeve is aligned with the through hole. At least one positioning block is disposed on an outer peripheral surface of the fixed sleeve.

The movable sleeve has an open end and a closed end. The fixed sleeve passes through the open end, so that the movable sleeve is covered on the fixed sleeve along an axial direction to be moved or rotated relative to the fixed sleeve along the axial direction. The movable sleeve further has a guiding slot opened on an outer peripheral surface thereof. The guiding slot at least includes a catching section for catching the positioning block and a release section extending toward the open end for guiding the positioning block into and out of the catching section.

The latching pin is coaxially disposed in the movable sleeve, extends out of the open end, and runs through the fixed sleeve. The catching section is used for catching the positioning block to fix the movable sleeve at a locking position and enable the latching pin to pass through the through hole to be inserted into the positioning hole that aligned with the through hole, so as to fix the sliding member; or the positioning block may move along the release section to be disengaged from the catching slot to move the movable sleeve to a release position, so that the latching pin is disengaged from the through hole and the positioning hole that aligned with the through hole.

In the above locking device, merely by rotating the movable sleeve to a small extent, the positioning block is made to enter into or be disengaged from the catching slot and the movable sleeve is moved along the axial direction. Then the latching pin locks or releases the sliding member with the movement of the movable member. Thus locking device of the present invention has a simple operating process. Furthermore, the catching slot can effectively fix the movable sleeve and the latching pin, so that the locking device achieves desirable locking efficacy and is easily assembled and disassembled and difficult to drop off.

### BRIEF DESCRIPTION OF THE DRAWINGS

FIG. 1A is a cross-sectional view of a rail assembly and a latching pin in the prior art;

FIG. 1B is a cross-sectional view of a rail assembly and a screwing member in the prior art;

FIG. 2 is an exploded view of a locking device according to a first embodiment of the present invention;

FIG. 3 is a three-dimensional cross-sectional view of the locking device according to the first embodiment of the present invention;

FIGS. 4A and 4B are perspective views of the locking device according to the first embodiment of the present invention;

FIG. 5A is an exploded view of a lockable rail assembly according to a second embodiment of the present invention;

FIG. 5B is a perspective view of the lockable rail assembly according to the second embodiment of the present invention; and

FIGS. 6A and 6B are perspective views of the lockable rail assembly according to the second embodiment of the present invention.

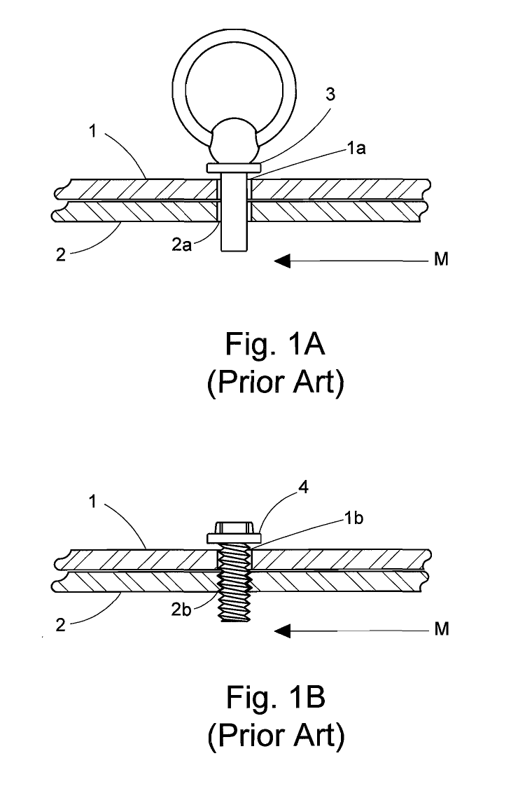

### DETAILED DESCRIPTION

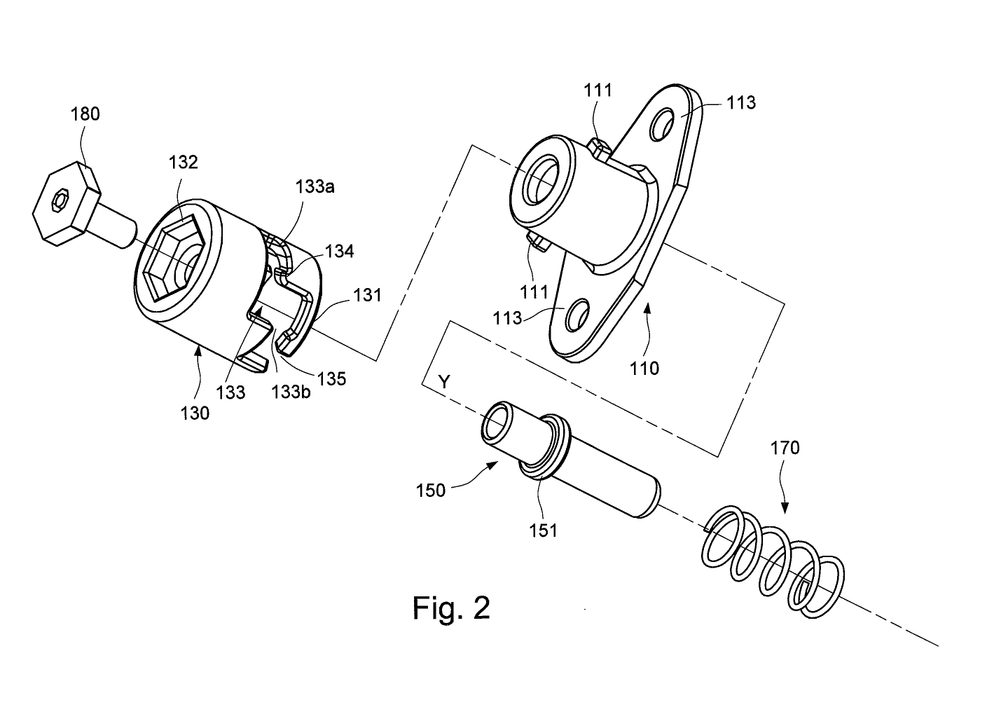

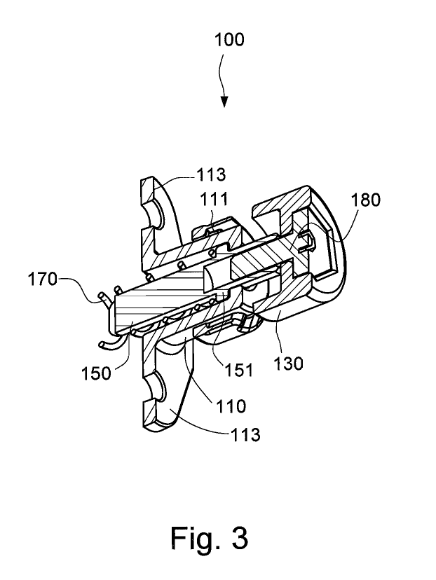

Referring to FIGS. 2 and 3, a locking device 100 for locking a rail assembly according to a first embodiment of the present invention is provided. The locking device 100 includes a fixed sleeve 110 with two ends opened, a movable sleeve 130, a latching pin 150, and an elastic member 170.

Referring to FIGS. 2 and 3, the fixed sleeve 110 has two open ends with one end being fixed on the rail assembly. The fixed sleeve 110 further includes two positioning blocks 111 and two lugs 113. Each of the positioning blocks 111 is a rectangular block disposed on an outer peripheral surface of the fixed sleeve 110. Each of the lugs 113 shapes like a flat plate and is disposed on an edge of one end of the fixed sleeve 110. The lugs 113 are provided for a screwing member such as a screw to run through, so as to fix the fixed sleeve 110 on the rail assembly.

Referring to FIGS. 2 and 3, the movable sleeve 130 has an open end 131 and a closed end 132. The fixed sleeve 110 passes through the open end 131 of the movable sleeve 130, so as to cover the movable sleeve 130 on the fixed sleeve 110 along a axial direction Y. The fixed sleeve 110 is provided to guide the movable sleeve 130, so as to move or to rotate the movable sleeve 130 relative to the fixed sleeve 110 about the axial direction Y.□

Referring to FIGS. 2 and 3, in which the movable sleeve 130 further has two guiding slots 133 opened on an outer peripheral surface of the movable sleeve 130. Each of the guiding slots at least includes a catching section 133a for catching the positioning block 111 and at least one release section 133b extending toward the open end 131.

Referring to FIGS. 2, 3, 4A, and 4B, the catching section 133a is perpendicularly to the axial direction Y for catching the positioning block 111, so as to fix the movable sleeve 130 at a locking position L in the axial direction Y.

The release section 133b extends toward the open end 131 for guiding the positioning block 111 into or out of the catching section 133a. A stop block 134 protruding toward the closed end 132 of the movable sleeve 130 is further disposed between the catching section 133a and the release section 133b, and is used for stopping the positioning block 111, so as to prevent the positioning block 111 from moving from the catching section 133a to the release section 133b. The release section 133b may extend to an edge of the open end 131 to form an opening 135, so as to guide the positioning block 111 to escape from the guiding slot 133 through the opening 135.

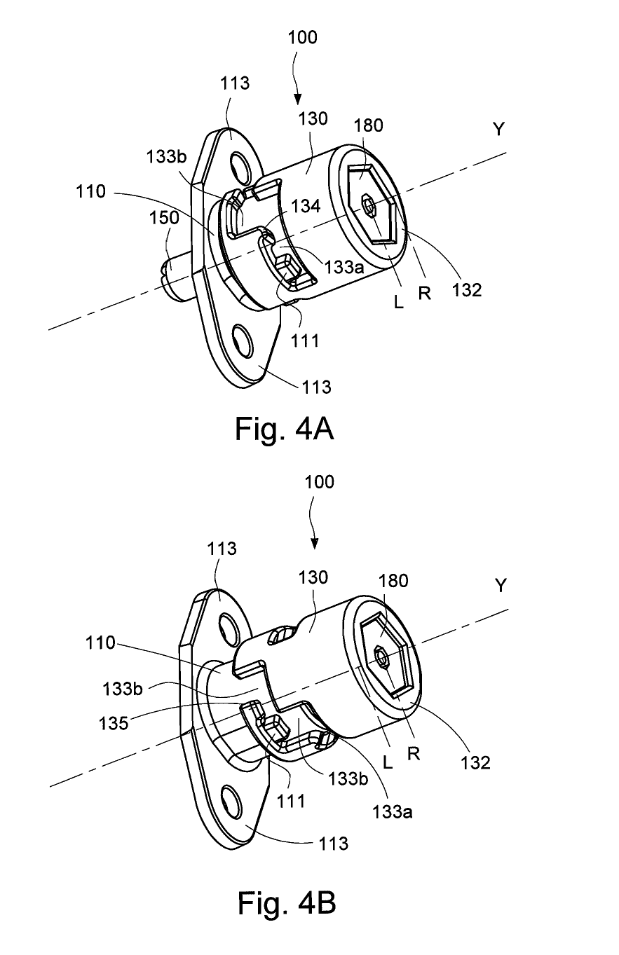

Referring to FIGS. 4A and 4B, in which after the positioning block 111 enters the release section 133b, the movable sleeve 130 may be moved to a release position R in the axial direction Y. The release section 133b may be a zigzag path formed by connections in multiple sections, instead of extending toward the open end 131 along a straight line.

Referring to FIGS. 2, 3, 4A, and 4B, the latching pin 150 is coaxially disposed in the movable sleeve 130, extends out of the open end 131, and runs through the fixed sleeve 110. A bolting member 180 runs through the closed end 132 from the exterior of the movable sleeve 130 and is locked to one end of the latching pin 150, so as to fix the latching pin 150 in the movable sleeve 130. The other end of the latching pin 150 extends out of the movable sleeve 130 and runs through the fixed sleeve 110.

Referring to FIGS. 2, 3, 4A, and 4B, one end of the elastic member 170 is pressed against the latching pin 150, and the other end is pressed against a surface of the rail assembly, so as to push the latching pin 150 to move away from the rail assembly.

The elastic member 170 in the first embodiment of the present invention is a compression spring normally compressed, and the elastic member 170 is sleeved on the latching pin 150. The latching pin 150 further includes a stop portion 151 disposed on a peripheral surface of the latching pin 150, so that one end of the elastic member 170 is pressed against the stop portion 151.

Referring to FIGS. 4A and 4B, when the positioning block 111 is located at the catching section 133a, the movable sleeve 130 cannot move toward a direction far away from the fixed sleeve 110, and is locked at the locking position L. Meanwhile, the elastic member 170 is compressed to generate a elastic force for pushing the movable sleeve 130 to move away from the fixed sleeve 110. Since the positioning block 111 is caught and fixed by the catching section 133a, the elastic force of the elastic member 170 forces the positioning block 111 to press against an edge of the catching section 133a. Meanwhile, the stop block 134 blocks the positioning block 111, and restricts the rotating extent of the movable sleeve 130, thereby preventing the positioning block 111 from entering the release section 133b from the catching section 133a. At this time, the latching pin 150 is protruded beyond the other end of the fixed sleeve 110, so as to be engaged into the rail assembly.

When intending to release the latching pin 150, the user has to apply a force to the movable sleeve 130 in a direction toward the fixed sleeve 110 and then rotate the movable sleeve 130. Therefore, the stop block 134 no longer blocks the positioning block 111. With the rotation of the movable sleeve 130, the positioning block 111 enters the release section 133b from the catching section 133a. After being released, the movable sleeve 130 is pushed by the elastic member 170 to move in a direction far away from the fixed sleeve 110 to reach the release position R. At this time, the latching pin 150 is withdrawn into the fixed sleeve 110 to be disengaged from the rail assembly. In the occasion that no elastic member 170 is disposed, the movable sleeve 130 may be pulled manually to be moved away from the fixed sleeve 110.

Only after the movable sleeve 130 is rotated to a small extent, the positioning block 111 is disengaged from the catching section 133a to move axially to drive the latching pin 150 to be disengaged from the rail assembly. Therefore, the embodiment of the present invention achieves a better fixing effect than a simple latch. Moreover, the movable sleeve 130 only needs to be rotated to a small extent, so that the operating process of the present invention is simplified as compared with a screwing member.

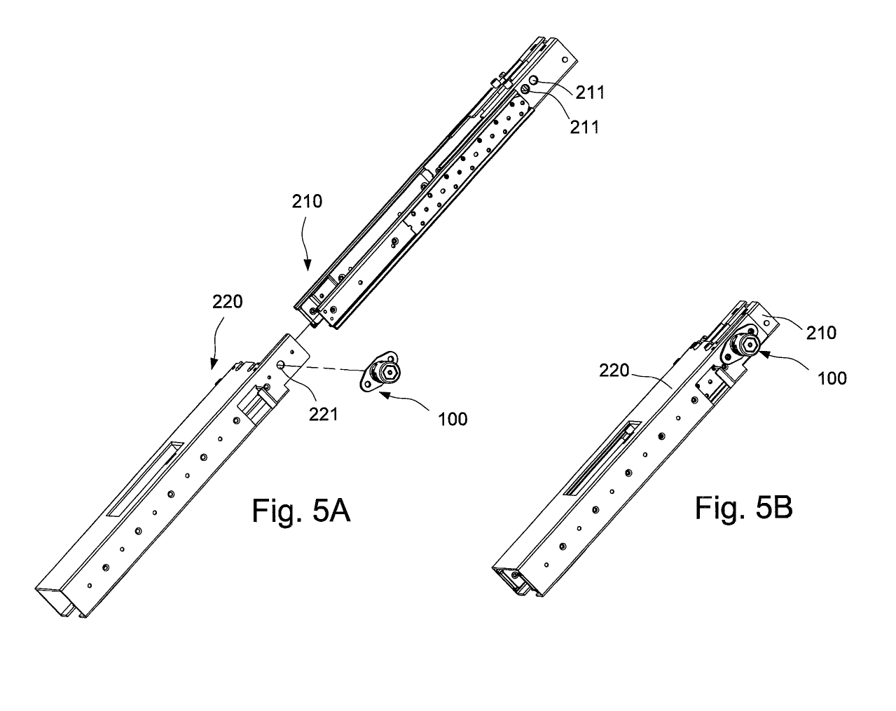

Referring to FIGS. 5A and 5B, a lockable rail assembly provided according to a second embodiment of the present invention includes a sliding member 210, a guiding member 220, and the locking device 100 as described in the first embodiment.

The sliding member 210 is movably combined with the guiding member 220 for limiting the movement of the sliding member 210 on the guiding member 220 in a sliding direction. One or more side surface of the sliding member 210 is covered by the guiding member 220. The sliding member 210 has a plurality of positioning holes 211 arranged in the sliding direction thereof. The guiding member 220 has a through hole 221. By moving the sliding member 210, one of the positioning holes 211 of the sliding member 210 is selectively aligned with the through hole 221.

The fixed sleeve 110 is fixed to the guiding member 220 with one of the two ends thereof being aligned with the through hole 221. One end of the elastic member 170 as described in the first embodiment is pressed against the latching pin 150, and the other end is pressed against the guiding member 220, so as to push the latching pin 150 to move away from the guiding member 220. When the through hole 221 is aligned with one of the positioning holes 211, the movable sleeve 130 is moved to the locking position L to drive the latching pin 150 to running through the fixed sleeve 110 to be inserted into the through hole 221 and the positioning hole 211, thereby fixing the sliding member 210 at a fixed point.

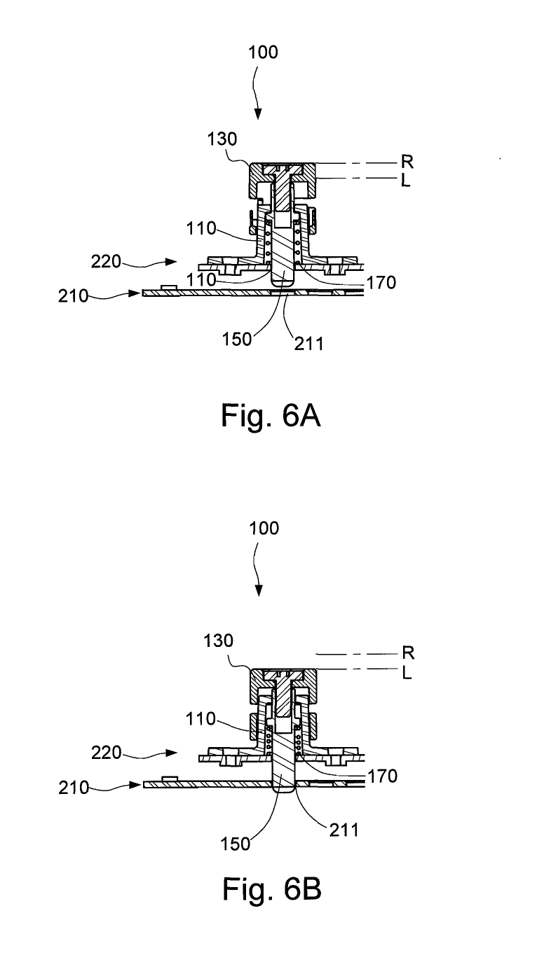

Referring to FIG. 6A, when the movable sleeve 130 is located at the release position R, the movable sleeve 130 is pushed by the elastic member 170 to move away from the guiding member 220, so that the latching pin 150 moves in a direction of being withdrawn into the fixed sleeve 110. At this time, the latching pin 150 is far away from the sliding member 210. Without being restricted by the latching pin 150, the sliding member 210 slides freely on the guiding member 220 in the sliding direction.

Referring to FIG. 6B, when one of the positioning holes 211 is aligned with the through hole 221 is aligned, the movable sleeve 130 is pressed toward the guiding member 220 and rotates, so that the positioning block 111 reaches the catching section 133a after passing through the release section 133b of the guiding slot 133, as shown in FIG. 4B. At this time, the movable sleeve 130 is still pushed by the elastic member 170, but the positioning block 111 is caught by the catching section 133a, so that the positioning block 111 is pressed against an edge of the catching section 133a, thereby fixing the movable sleeve 130 at the locking position L. Meanwhile, the latching pin 150 running through the guiding member 220 through the positioning hole 211 and is inserted into the through hole 221 to fix the sliding member 210 at a fixed position.

Through the locking effect of the locking device 100, the sliding member 210 can be fixed effectively on the guiding member 220. Only after the movable sleeve 130 is rotated, can the latching pin 150 be disengaged from the positioning hole 211, thereby avoiding the problem that the latching pin 150 drops off easily. Meanwhile, the movable sleeve 130 only needs to slide to a small extent to start the operation, which effectively simplifies the operating process.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A locking device, for locking a rail assembly, the locking device comprising:
a fixed sleeve with two ends opened, fixed on the rail assembly, and having at least one positioning block disposed on an outer peripheral surface of the fixed sleeve;
a movable sleeve, comprising an open end and a closed end, and the fixed sleeve passing through the open end to cover the movable sleeve on the fixed sleeve along an axial direction, so as to move or to rotate the movable sleeve relative to the fixed sleeve about the axial direction; and the movable sleeve further comprising:
a guiding slot, opened on an outer peripheral surface of the movable sleeve, and comprising a catching section for catching the positioning block and at least one release section extending toward the open end of the movable sleeve for guiding the positioning block into and out of the catching section; and
a latching pin, coaxially disposed in the movable sleeve, extending out of the open end of the movable sleeve, and running through the fixed sleeve, for engaging into the rail assembly.

2. The locking device as claimed in claim 1, wherein the catching section of the guiding slot is perpendicularly to the axial direction, for catching the positioning block, so as to fix the movable sleeve at a locking position.

3. The locking device as claimed in claim 1, wherein the release section extends to an edge of the open end of the movable sleeve to form an opening, so as to guide the positioning block to escape from the guiding slot through the opening.

4. The locking device as claimed in claim 1, further comprising:
an elastic member, having one end pressed against the latching pin and the other end pressed against the rail assembly for pushing the latching pin to move away from the rail assembly.

5. The locking device as claimed in claim 4, wherein the latching pin further comprises a stop portion disposed on a peripheral surface of the latching pin, and the end of the elastic member that pressing against the latching pin is pressed against the stop portion.

6. The locking device as claimed in claim 5, wherein the elastic member is a compression spring sleeved on the latching pin.

7. The locking device as claimed in claim 1, further comprising a bolting member, for running through the closed end of the movable sleeve to fix the latching pin to the movable sleeve.

8. The locking device as claimed in claim 1, wherein the fixed sleeve further comprises at least one lug disposed on an edge of one end of the fixed sleeve for fixing the fixed sleeve on the rail assembly.

9. A lockable rail assembly, comprising:
a guiding member, having a through hole;
a sliding member, having at least one side surface being covered by the guiding member and being movable combined with the guiding member, wherein the sliding member has a plurality of positioning holes arranged in a sliding direction of the sliding member, and one of the positioning holes is selectively aligned with the through hole as the sliding member moves;
a fixed sleeve with two ends opened, fixed on the guiding member with one of the two ends of the fixed sleeve aligned with the through hole, and having at least one positioning block disposed on an outer peripheral surface of the fixed sleeve;
a movable sleeve, comprising an open end and a closed end, and the fixed sleeve passing through the open end of the movable sleeve to cover the movable sleeve on the fixed sleeve along a axial direction, so as to move or to rotate the movable sleeve relative to the fixed sleeve about the axial direction, the movable sleeve further comprising:
a guiding slot, opened on an outer peripheral surface of the movable sleeve, and comprising a catching section for catching the positioning block and at least one release section extending toward the open end of the movable sleeve for guiding the positioning block into and out of the catching section; and
a latching pin, coaxially disposed in the movable sleeve, extending out of the open end of the movable sleeve, and running through the fixed sleeve for being inserted into one of the positioning holes.

10. The lockable rail assembly as claimed in claim 9, wherein the catching section of the guiding slot is perpendicularly to the axial direction, for catching the positioning block, so as to fix the movable sleeve at a locking position.

11. The lockable rail assembly as claimed in claim 9, wherein the release section extends to an edge of the open end of the movable sleeve to form an opening, so as to guide the positioning block to escape from the guiding slot through the opening and to move the movable sleeve to a release position.

12. The lockable rail assembly as claimed in claim 9, further comprising:
an elastic member, having one end pressed against the latching pin and the other end pressed against the guiding member for pushing the latching pin to move away from the guiding member.

13. The lockable rail assembly as claimed in claim 12, wherein the latching pin further comprises a stop portion disposed on a peripheral surface of the latching pin, and the end of the elastic member that pressing against the latching pin is pressed against the stop portion.

14. The lockable rail assembly as claimed in claim 13, wherein the elastic member is a compression spring sleeved on the latching pin.

15. The lockable rail assembly as claimed in claim 9, further comprising a bolting member, for running through the closed end of the movable sleeve to fix the latching pin to the movable sleeve.

16. The lockable rail assembly as claimed in claim 9, wherein the fixed sleeve further comprises at least one lug disposed on an edge of one end of the fixed sleeve for fixing the fixed sleeve on the guiding member.
